(19) United States
(12) Patent Application Publication
(10) Pub. No.: US 2005/0087420 A1
(43) Pub. Date: Apr. 28, 2005

(54) Powertrain

(75) Inventors: Michael Schafer, Ketsch (DE); Hans Hauck, Schwabisch Hall (DE)

Correspondence Address: BORGWARNER INC.;POWERTRAIN TECHNICAL CENTER, PATENT DEPARTMENT, SUITE100, 3800 AUTOMATION AVENUE, AUBURN HILLS, MI, 48326, US

(73) Assignee: BorgWarner Inc.

(21) Appl. No.: 10/962,370

(22) Filed: Oct. 9, 2004

(30) Foreign Application Priority Data
Aug. 24, 2004 (EP) 04020018.0
Oct. 11, 2003 (EP) 03023013.0

(51) Int. Cl. F16D 21/00; F16D 25/00

(52) U.S. Cl. 192/55.61; 192/87.11; 192/212

(57) ABSTRACT

A powertrain with a torsional vibration damper having a disk and a torsional vibration damper housing which is coupled to the disk elastically so that it can be deflected from rotation about a rotational axis and which at least partially surrounds the disk. A clutch device with a clutch housing is provided that can rotate about the rotational axis. To increase the inertia of masses at the output of the torsional vibration damper the torsional vibration damper housing is connected without rotational play to the clutch housing.

### FIELD

The invention pertains to a powertrain having a clutch device, and in particular to a powertrain having a torsional vibration damper.

### BACKGROUND

Powertrains may have a torsional vibration damper with a disk with a torsional vibration damper housing. The housing may be coupled to the disk in a spring-elastic way so that it can be deflected from rotation about a rotational axis. The housing may surround the disk at least partially, and with a clutch device, can rotate about the rotational axis.

EP 1 195 537 A1 describes a powertrain having a clutch housing of a double clutch being connected to the disk of a torsional vibration damper in an axis-parallel construction, while the torsional vibration damper housing is connected to a crankshaft.

DE 102 03 618 A1 describes a powertrain having a clutch housing of a double clutch being connected to the disk of a torsional vibration damper in a concentric construction. The torsional vibration damper housing is connected to a crankshaft.

Other powertrains with a wet-running starter clutch have a clutch housing being connected directly to a bending, flex and/or swash plate, which in turn may be coupled to the torsional vibration damper connected to the crankshaft.

### SUMMARY

A powertrain is disclosed having a torsional vibration damper, with a disk and a torsional vibration damper housing. The housing is coupled to the disk spring elastically so that it can be deflected from rotation about a rotational axis and which at least partially surrounds the disk. The powertrain includes a clutch device, and may include a wet-running starter clutch, with a clutch housing that can rotate about the rotational axis. The torsional vibration damper housing is connected without rotational play to the clutch housing to provide an improved torsional vibration behavior of the powertrain.

The torsional vibration behavior of the powertrain can be improved, for example, when the torsional vibration damper has a large damper secondary mass on the output side. In order to reduce the additional material requirements necessary for providing a large damper secondary mass, instead of an additional flywheel mass (e.g., in the form of a separate flywheel), the torsional vibration damper housing is connected to the clutch housing without rotational play. Torque generated by an internal combustion engine may consequently be transferred from the inside via the disk and the spring-elastic coupling to the torsional vibration damper housing and thus to the clutch housing. The output-side secondary mass of the torsional vibration damper may accordingly be formed by the torsional vibration damper housing and the clutch housing, and thus can be large relative to the portion of the primary mass essentially formed just by the disk on the input side.

The torsional vibration damper and the clutch device may be separate components to reduce structural space and/or materials, the torsional vibration damper housing and the clutch housing together may form an enclosing housing surrounding both the clutch device and the torsional vibration damper. The combined torsional vibration damper and clutch housing can then be assembled, e.g., from two half-shells, which can overlap, e.g., in the region of the torsional vibration damper, in order to increase the stability at this point. The clutch device can also be prefabricated together with the torsional vibration damper as a type of module to which additional components can be flange-mounted.

In addition to compressed means used for activating the clutch, a coolant may be provided for cooling the clutch device. This coolant can be located within an additional housing, which surrounds the clutch and torsional vibration damper housing and thus the clutch device and the damper. To keep the required amount of operating means low, the volume storing the operating means can be small. Therefore, the enclosing housing itself is sealed from the surrounding for storing operating means, especially hydraulic fluid, such as compressed and/or cooling oil. The cooling oil used for cooling the clutch can be used with the corresponding guidance of the fluid also can be used as a medium for damping the rotational movement of the primary and secondary element, i.e., the disk and housing of the torsional vibration damper.

For cushioning axial and/or radial offsets, as well as impacts or the like, in the powertrain may have a bending, flex, and/or swash plate, which is connected to the disk of the torsional vibration damper, e.g., without rotational play, preferably at an inner periphery.

To set the damping behavior of the system, a flywheel mass can also be provided (arranged before the bending, flex and/or swash plate), which is connected to the bending, flex, and/or swash plate, without rotational play, and preferably at an outer periphery. For the same reason, there can be a flywheel mass, which is connected to the disk of the torsional vibration damper, without rotational play, and preferably at an inner periphery. For the reasons already mentioned above, a bending, flex, and/or swash plate can be provided, which is connected to the flywheel mass, especially without rotational play, preferably at an outer periphery. In this case, the flywheel mass is connected after the bending, flex, and/or swash plate.

As already given from the configurations mentioned above, the clutch device can be a double clutch, preferably wet-running, in an axis-parallel construction; a double clutch, preferably wet-running, in a concentric arrangement; or a starter clutch, preferably wet-running.

### BRIEF DESCRIPTION OF THE DRAWINGS

FIG. 1 is a cross section view of a powertrain according to a first embodiment of a double clutch in an axis-parallel arrangement in axial half-section;

FIG. 2 is a cross section view of a powertrain according to a second embodiment of a double clutch in an axis-parallel arrangement in axial half-section;

FIG. 3 is a cross section view of a powertrain according to a third embodiment of a double clutch in an axis-parallel arrangement in axial half-section;

FIG. 4 is a cross section view of a powertrain of a wet-running starter clutch in axial half-section.

### DETAILED DESCRIPTION

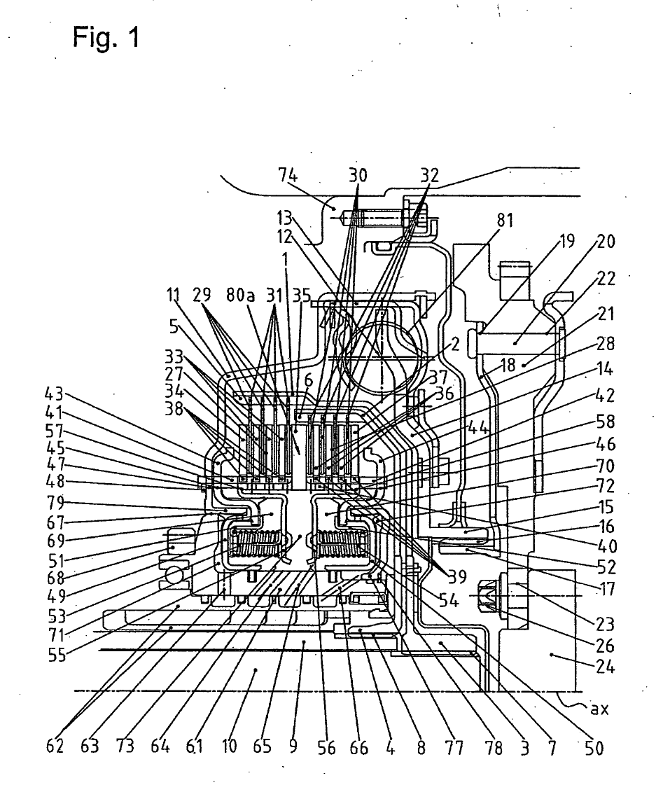

Powertrains having a torsional vibration damper, with a disk and a torsional vibration damper housing, are illustrated in FIGS. 1-4. In the figures, the same reference symbols may be used to designate identical or functionally identical components. The housing is coupled to the disk spring elastically so that it can be deflected from rotation about a rotational axis and which at least partially surrounds the disk. The powertrain includes a clutch device, and may include a wet-running starter clutch, with a clutch housing that can rotate about the rotational axis. The torsional vibration damper housing is connected without rotational play to the clutch housing to provide an improved torsional vibration behavior of the powertrain.

FIG. 1 shows a cut-out of a first embodiment of a powertrain for a motor vehicle with a bending/swash/flex plate 18 having a torsional vibration damper 12 and a double clutch 80a in an axis-parallel arrangement. A crankshaft 24 can rotate about a rotational axis ax and is coupled to an internal combustion engine, a motor, or the like on the drive side of the powertrain. Two transmission input shafts, namely a central or full shaft 10 and a hollow shaft 9, can rotate about the rotational axis ax. The shafts can be coupled, e.g., to a transmission or the like (not shown here), on the driven side of the powertrain.

The first transmission input shaft, namely the central or full shaft 10, can be provided for operating odd gears (e.g., 1, 3, 5, . . . ) and the second transmission input shaft, namely the hollow shaft 9, can be provided for operating even gears (e.g., 2, 4, 6, . . . ) of the motor vehicle. The reverse gear could be assigned to both the first transmission input shaft (central or full shaft 10) and also the second transmission input shaft (full shaft 9) of the transmission.

In addition to the drive shaft 24 and the driven shafts 9, 10 arranged interspersed relative to each other coaxially, the powertrain further comprises a flywheel mass 21, the bending/swash plate 18, torsional vibration damper 12, and the double clutch 80a in an axis-parallel arrangement. The powertrain is enclosed by a clutch bell 74. The clutch bell 74 encloses the two individual clutches of the double clutch 80a, embodied as wet-running multi-plate clutches, the torsional vibration damper 12, the bending and/or swash plate 18, and the flywheel mass 21.

The rotational or torsional vibration damper 12 comprises a drive-side primary element 14 and a driven-side secondary element 11, 13 that can rotate against the force of a spring element. The primary element 14 has the shape of a disk. The secondary element consists of two half-shells 11, 13 in the present embodiment. The two half-shells 11, 13 of the secondary element form a torsional vibration damper housing. This torsional vibration damper housing houses both the primary element 14 and the spring element comprising a plurality of spring packets with several helical springs 81 arranged in the circumferential direction. The two half-shells 11, 13 together form a clutch housing enclosing the two individual clutches of the double clutch.

Each individual clutch of the double clutch 80a includes an outer plate carrier 1, 2 and a common inner plate carrier 40. The outer plate carrier of the first clutch is designated the first outer plate carrier 1 in the following, and the outer plate carrier of the second clutch is designated the second outer plate carrier 2. The two outer plate carriers 1, 2 have half-shell shapes, wherein the first outer plate carrier 1 projects over the second outer plate carrier 2 in the axial direction. The inner plate carrier 40 has an essentially cylindrical shape and extends over the axial regions of the half-shells 1, 2. The two outer plate carriers 1, 2 have internal toothed sections 5, 6, which are used for guidance of frictional plates 29, 30, which can move in the axial direction but are essentially without rotational play and which each have four corresponding external toothed sections 31, 32 in the present case. The frictional plates are typically also called external plates 29, 30.

In a corresponding way, on the outer periphery of the inner plate carrier sections of the common internal plate carrier 40 assigned to the external plate carriers 1, 2, there are external toothed sections 41, 42, in which frictional plates, the so-called internal plates 36, with internal toothed sections can move in the axial direction but are without rotational play. The two internal plate carrier sections are separated from each other by a common end plate 35. At the two outer ends of the common internal plate carrier 40, pressure plates 34, 37 are guided in the same way as the previously described internal plates 36 so that they can move in the axial direction but are essentially without rotational play.

The outer frictional plates/external plates 29, 30, the inner frictional plates/internal plates 33, 36, and also the two pressure plates 34, 37, and the common end plate 35 alternately engage like teeth in a known way a plate packet 27, 28 assigned to a clutch. The two plate packets 27, 28 with the corresponding frictional plates 29, 30, 33, 34, 35, 36, 37 are arranged parallel to each other in the axial direction on the common inner plate carrier 40. In the present embodiment, the frictional surfaces of all frictional plates 29, 30, 33, 34, 35, 36, 37 are essentially the same size, so that the individual clutches have an equal power output. It is also possible that the frictional surfaces of the frictional plates have different size diameters.

Components of the clutches further include piston/cylinder units, which are described in detail in the following and which are used for activating the clutches. In particular, a hydraulically activatable activation piston 43, 44 is assigned to each clutch. Each of these activation pistons 43, 44 can be pressed against one of the pressure plates 34, 37 to transfer force and to generate a friction-tight connection between the individual frictional plates 29, 30, 33, 34, 35, 36, 37 and thus to activate the corresponding clutch.

The two individual clutches of the double clutch 80a are activated inwards, with the reaction forces acting against the common end plate 35. The common inner plate carrier 40 intersperses the two annular activation pistons 43, 44 necessary for activating the clutches. For this purpose, the inner plate carrier has on the end side over the outer periphery essentially axial crossbars, which engage like teeth in corresponding openings 45, 46 of the corresponding activation pistons 43, 44. On one end, these crossbars also engage in corresponding openings 47 in the half-shell 11. The openings 47 in the half-shell 11 (and also usually the openings 45, 46 in the activation pistons 43, 44) are tuned to each other in their peripheral dimensions, so that relative rotation is not possible. The inner plate carrier 40 is connected in this way without rotational play to the half-shell 11.

To reduce axial shifting of the inner plate carrier 40, a safety ring 48 is provided, which keeps the inner plate carrier 40 fixed on the clutch housing 11, 13. The half-shell 11 is rigidly connected to a clutch hub 61 at the position of a seam 67. This clutch hub 61 surrounds the two transmission input shafts 9, 10 coaxially. The clutch hub 61 carries a half-shell-shaped cylinder 77. This cylinder 77 is limited in its axial movement by a safety ring 78.

The component of the clutch housing 11, 13 is a cylinder 79 of the type corresponding to the cylinder 77. The activation pistons 43, 44 can move in the axial direction on the two cylinders 77, 79. Cylinder 77 and activation piston 44 are used for support and centering for the inner plate carrier 40.

In addition to the previously mentioned activation pistons 43, 44, by means of which the corresponding pressure plates 34, 37 of the plate packets 27, 28 can be shifted in the direction of the common end plates 35, the activation devices for the two clutches each include a pressure piston 49, 50, a piston 51, 52, a compensating piston 55, 56, and also a plurality of helical screws 53, 54 arranged in the circumferential direction. The corresponding activation pistons 43, 44 are supported outwards against the corresponding pressure pistons 49, 50, which can move in the axial direction on the cylinders 79, 77 and on the outer periphery of the clutch hub 61. On the inside, the activation pistons 43, 44 support the pistons 51, 52. These are in turn supported on the inside against the helical springs 53, 54. The helical springs 53, 54 are supported on the inside, against the outer surfaces of the compensating pistons 55, 56. These compensating pistons 55, 56 are supported with their inner surfaces against radially inwards circular peripheral crossbars 57, 58 on the inner plate carrier 40.

Although the entire clutch system could be supported directly on the second transmission input shaft, namely the hollow shaft 9, for the present embodiment, a separate flange-type component, in the following designated carrier 62, is provided, which coaxially surrounds the two transmission input shafts, the hollow shaft 9, and the full shaft 10, and on which the clutch hub 61 is supported so that it can rotate about the rotational axis ax. For supporting the clutch hub 61 on the carrier 62, existing roller bearings are used. As an alternative for low costs, sliding bearing can be used.

The carrier 62 can be embodied as one piece or as multiple pieces in both the axial and radial directions. In the present case, the carrier 62 is embodied in two pieces. It consists of a jacket and a bushing enclosed by this jacket. The cylindrical jacket-shaped bushing has longitudinal grooves, which have different lengths and which extend in the axial direction in the outer periphery of the bushing. The jacket has four grooves extending in the circumferential direction corresponding to the arrangement of the previously mentioned longitudinal grooves. These circumferential grooves are connected via radial openings (not shown here) to the corresponding longitudinal grooves.

Corresponding to the circumferential grooves, the clutch hub 61 has four openings, which extend essentially in the radial direction and partially inclined to the axial direction and which are designated in the following as hydraulic fluid channels 63, 64, 65, and 66. Through these hydraulic fluid channels 63, 64, 65, 66, hydraulic fluid is fed to the small volumes formed by the pistons 43, 44, 49, 50, 55, 56 (first hydraulic fluid activation chamber 71, second hydraulic fluid activation chamber 72, first hydraulic fluid compensation chamber 69, second hydraulic fluid compensation chamber 70, coolant chamber 73).

Through the first hydraulic fluid channel 63, the first hydraulic fluid activation chamber 71 can be pressurized with hydraulic fluid. This hydraulic fluid pressure presses the pressure piston 49, and thus the activation piston 45 and the piston 51, inwards, against the pressure of the helical springs 53. Such a shift of the activation piston 45 has the consequence that its outer periphery is pressed against the pressure plate 34 of the first clutch, activating this clutch.

In the same way, through the fourth hydraulic fluid channel 66, the second hydraulic fluid activation chamber 72 can be charged with hydraulic fluid. Due to this hydraulic fluid pressure, the pressure piston 50, and thus the activation piston 44 and the piston 52, are pressed inwards, against the pressure of the helical springs 54. This has the consequence in a corresponding way that the outer periphery of the activation piston 44 is pressed against the pressure plate 37 of the second clutch, activating this clutch.

Through the two hydraulic fluid channels 64 and 65, on one side, the hydraulic fluid compensation chambers 69, 70 and also the coolant chamber 73 are filled with hydraulic fluid. The hydraulic fluid in the hydraulic fluid compensation chambers 69, 70 is used to generate a centrifugal force-specific hydraulic fluid counterpressure, which acts against the centrifugal force-specific pressure increase in the hydraulic activation chamber 71, 72. For cooling the frictional plates 29, 30, 33, 34, 35, 36, 37, the hydraulic fluid in the coolant chamber 73 is guided through radial (not shown here) openings in the inner plate carrier 40 to the frictional plates 29, 30, 33, 34, 35, 36, 37.

The crankshaft 24 is screwed with the internal periphery of the flywheel mass 21 (screw 26, hole 23). The outer periphery of the flywheel mass 21 is riveted with the outer periphery of the bending/swash plate 18 (outer edge hole 19, rivet 20, hole 22). The inner periphery of the bending/swash plate 18 carries an inner flange 17 with an external toothed section. This external toothed section engages like a plug connection 16 in an internal toothed connection of the primary element 14 of the torsional vibration damper 12, creating a connection without rotational play. The half-shell 13 of the torsional vibration damper 12 forming the secondary element is connected without rotational play to the inner plate carrier 40 of the double clutch in the previously described way. The two clutches (plate packets 27, 28; activation pistons 44, 45) connect the inner plate carrier 40 switchably to the outer plate carriers 1, 2, which are connected in turn via the flanges 3, 4 by means of plug connections 7, 8 without rotational play to the two transmission input shafts 9, 10. A torque introduced via the crankshaft 24 can thus be transferred by means of the double clutch to one of the two transmission input shafts 9, 10. The rotational movement introduced via the crankshaft 24 about the rotational axis ax can also drive a hydropump (not shown here) for providing the previously mentioned hydraulic fluid pressure through a pump drive gear 68 arranged on the clutch hub 61.

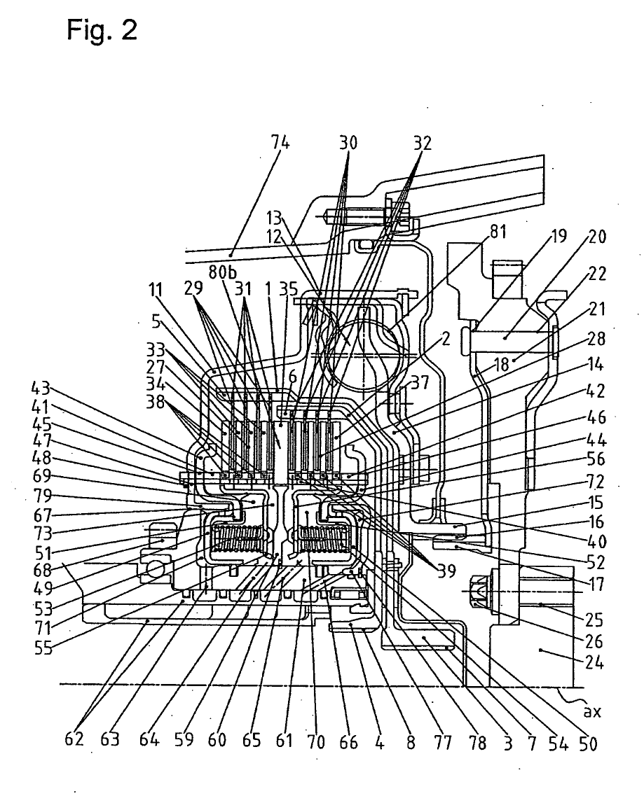

FIG. 2 shows a cut-out from another powertrain according to the invention for a motor vehicle with a bending/swash plate 18, a torsional vibration damper 12, and a double clutch 80b in axis-parallel arrangement. The embodiment shown in FIG. 2 of a powertrain according to the invention differs from the previously described powertrain according to FIG. 1 in the configuration of the double clutch 80b. In the double clutch 80b shown in FIG. 2, the compensation pistons 55, 56 are not supported on the circular crossbars 57, 58 arranged on the inner plate carrier, but instead on a ring element 59, which is supported contact-limited by a safety ring 60 on the clutch hub 61. In addition to the function of supporting the compensation pistons 55, 56 and the activation devices consisting of activation pistons 43, 44, pressure pistons 43, 50, pistons 51, 52, and helical springs 53, 54 in the axial direction, the ring element 59 has the task of guiding the hydraulic fluid flow to he friction plates 29, 30, 33, 34, 35, 36, 37. For this purpose, the ring element 59 has on the outer periphery side a thick section, which deflects incoming hydraulic fluid in the axial direction.

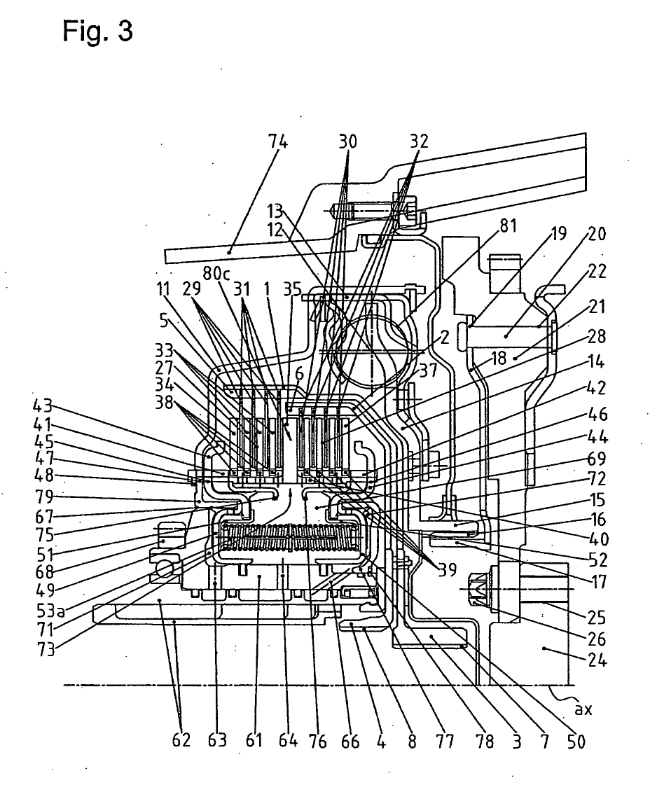

FIG. 3 shows a cut-out from another powertrain of the previously mentioned type with a third variant of a double clutch 80c. In the embodiment shown in FIG. 3, the double clutch 80c differs from that according to the first two embodiments in that the compensation pistons 55, 56 were eliminated. Instead of the helical springs 53, 54 assigned to the individual activation pistons 43, 44, now a plurality of helical springs 53a arranged in the circumferential direction are provided, against which the activation piston 43 on one side is supported by the piston 51 and the activation piston 44 on the other side is supported by the piston 52. Instead of the two compensation pistons 55, 56, now two coolant guide sheets 75, 76 are provided, which are connected rigidly to the inner plate carrier and which guide the hydraulic fluid to the friction plates 29, 30, 33, 34, 35, 36, 37 for their cooling.

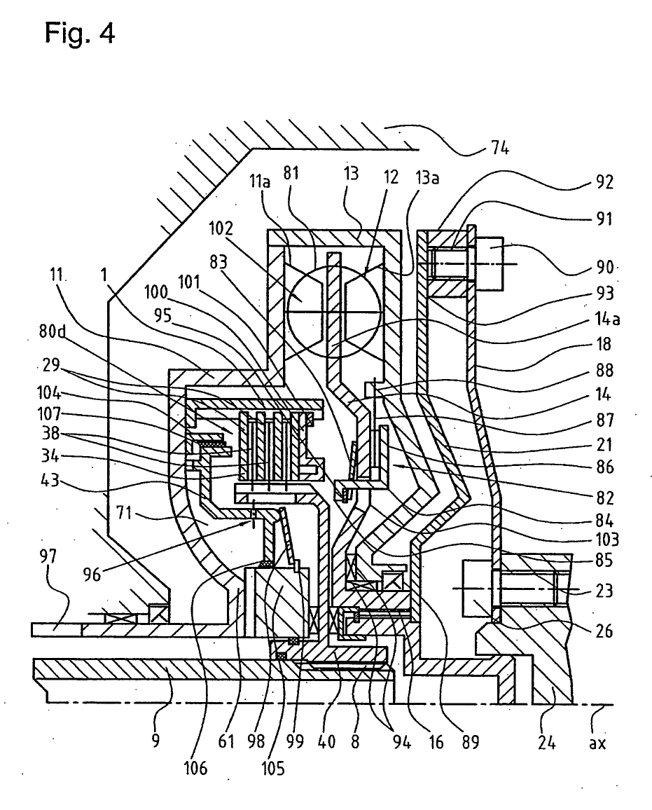

FIG. 4 shows a cut-out of a fourth embodiment of a powertrain according to the invention for a motor vehicle with a drive shaft in the form of a crankshaft 24, with a bending/swash plate 18, with a flywheel mass 21, with a torsional vibration damper 12, with a wet-running starter clutch 80d, and with a driven shaft in the form of a transmission input shaft 9. The crankshaft 24, which can rotate about a rotational axis ax and which, e.g., is coupled with an internal combustion engine, a motor, or the like on the drive side of the powertrain. The transmission input shaft, namely the hollow shaft 9, which can rotate about the rotational axis ax, is coupled to a transmission (not shown) on the driven side of the powertrain.

The entire powertrain is enclosed as in the preceding embodiments by a so-called clutch bell 74. The clutch bell 74 encloses the starter clutch 81, the torsional vibration damper 12, the flywheel mass 21, and also the bending and/or swash plate 18.

The torsional vibration damper 12 is also embodied here using known means and methods. In the present embodiment, it includes a drive-side primary element 14 and a driven-side secondary element 11, 13, which can rotate about the rotational axis ax against the force of a spring device 102 and a frictional device 82. The primary element has the shape of a disk 14. In the present embodiment, the secondary element consists of two half-shells 11, 13.

The spring device 102 includes a plurality of spring packets, which are arranged in the circumferential direction and which each include in turn several helical springs 81. For spring-elastic coupling of the primary and secondary element 11, 13, 14, each spring packet is supported on one end against a catch 14a of the primary element 14 and on the other end against a corresponding catch 11a, 13a of the secondary element 11, 13.

The frictional device 82 acting parallel to the spring device 102 includes a ring part 84 with fingers, which extend in the axial direction and which are led through corresponding openings 103 in the (primary) disk 14. The ends of the fingers of the ring part 84 extend in the radial direction inwards and form a support collar 85. On the other side, the ring part 84 extends in the shape of a disk radially outwards, forming a pressure collar 86. In the axial direction between the pressure collar 86 and the (primary) disk 14, there is an annular friction plate 87 carrying frictional coatings on both end surfaces. The friction plate 87 has an external toothed section on the outer peripheral side, which engages in an internal toothed section of a retaining collar 88 that connects integrally to the half-shell 13 of the secondary element of the torsional vibration damper 12 and that points in the axial direction towards the interior of the torsional vibration damper 12. In this way, the friction plate 87 is connected so that it can move in the axial direction but without rotational play to the half-shell 13 of the secondary element 11, 13. Furthermore, a plate spring 83 is provided, which is supported on one side against the (primary) disk 14 and on the other side against the support collar 85 held by a retaining ring 95. The spring force of the plate spring 83 presses the pressure collar 86, generating a frictional lock, against the friction plate 87 and the (primary) disk 14.

The two half-shells 11, 13 of the secondary element form a torsional vibration damper housing. This torsional vibration damper housing holds both the primary element 14 and also the spring device 102 and the frictional device 82. In addition to the half-shells 11, 13, the starter clutch 80d includes an outer plate carrier 1 carrying an outer plate 29 and an inner plate carrier 40 carrying an inner plate 38, as well as an activation piston/cylinder unit for activating the clutch 80d.

The outer plates 29 have on the outer periphery an external toothed section, which engages in an internal toothed section formed on the internal periphery of the outer plate carrier 1 connected without rotational play to the half-shell 11. The outer plates are thus guided without rotational play but can move in the axial direction. The inner plates 38 have on the inner periphery an internal toothed section, which engage in an external toothed section formed on the outer periphery of the inner plate carrier 40. Therefore, the inner plates are guided without rotational play but can move in the axial direction. The outer plate lying closest to an activation piston 43 forms a pressure plate 34. The outer plate lying farthest from the activation piston 40 forms an end plate 100. This end plate 100 is secured by means of a safety ring 101 against shifting in an axial direction.

The activation piston/cylinder unit includes the previously mentioned activation piston 43 and two cylinders 104, 105 connected without rotational play to the half-shell 11, by means of which the activation piston 43 can move in the axial direction and is sealed against the surroundings with the aid of lip seals 106, 107. The activation piston 43 is supported by means of a plate spring 98 held by a safety ring 99 on the cylinder 105 elastically via a clutch hub 105 connected without rotational play to the shell 11 on the clutch housing consisting of the half-shells 11, 13.

The activation piston 43, the half-shell 11, and the two cylinders 104, 105 define a hydraulic fluid activation chamber 71, to which an operating medium, namely a hydraulic fluid, can be supplied and also discharged for activating the clutch 80d with the aid of the activation piston 43. The activation piston 43 further has a plurality of aperture openings 96, which are distributed over the periphery and by means of which pressurized medium is diverted for clutch cooling.

The housing end 97 is formed in the clutch bell 74 for integrating a drive of a hydraulic pump for supplying the clutch 80d and the transmission with pressurized and cooling medium. The operating medium (pressurized medium and cooling medium) is fed in the cylindrical space between the housing end 97 of the pump drive and the transmission input shaft 9. From there, the pressurized medium is led into the hydraulic activation chamber 71 and also through the aperture openings 96 to the plates 29, 38. The cooling medium is led back through the transmission input shaft formed as hollow shaft 9 into the hydraulic cycle.

In the vicinity of its outer periphery, the crankshaft 24 has a plurality of threaded holes 23 arranged in the circumferential direction. Corresponding to these holes, the bending/swash plate 18 (also frequently called a flex plate) has a plurality of holes in the vicinity of its inner periphery. With the aid of screws 26, the flex plate 18 is screwed to the crankshaft 24. On its outer periphery, the flywheel mass 21 has a ring 92 welded at a weld point 93. This ring has a plurality of threaded holes 91 in the circumferential direction. Corresponding to the threaded holes 91, the flex plate 18 has openings on the outer peripheral side. With the aid of screws 90, the flex plate 18 is screwed to the flywheel mass 21. The flywheel mass 21 is connected at its inner periphery without rotational play, e.g., via a plug connection 16 to the disk 14 of the torsional vibration damper 12 forming the primary element. The disk 14 is coupled spring-elastically via the spring device 102 and so that it can rotate about the rotational axis ax to the half-shells 11, 13, which form the secondary element, representing both the torsional vibration damper housing and the clutch housing, and which are connected to each other without rotational play. The half-shell 11 is connected without rotational play to the outer plate carrier 1 and the outer plates 29 carried by this carrier. The inner plates 34 alternately adjacent to the outer plates 29 are held in a corresponding way without rotational play by the inner plate carrier 40. The inner plate carrier 40 is in turn connected by a plug connection 8 to the hollow shaft 9 representing the driven shaft or transmission input shaft.

The disk 14 and the disk-shaped flywheel mass 21 connected to the flex plate 18 together form a torsional vibration damper input. The disk 14 and the disk-shaped flywheel mass 21 are separated from each other sealed by a toothed section 16 in order to guarantee the assembly of the arrangement. The torsional vibration damper output includes the actual clutch housing with the two half-shells 11, 13 and the clutch hub 61, which can rotate about the rotational axis ax on the inner plate carrier 40 of the starter clutch 80d, as well as the outer plate carrier 1, the outer plates 29, and the activation piston/cylinder unit with the activation piston 43 and its restoring spring 98, as well as the cylinders 104, 105 guiding the activation piston 43. The torsional vibration damper input and torsional vibration damper output are supported relative to each other by means of a corresponding bearing 94 so that they can rotate about the rotational axis ax and are sealed from the surroundings defined by the clutch bell 74.

If the crankshaft 24 is connected to an internal combustion engine, then the motor torque is transferred through the crankshaft 24, the flex plate 18, the flywheel mass 21, and the torsional vibration damper 12 into the starter clutch. If the clutch 80d is activated, then the motor torque is transferred starting from the outer plates 29 carried by the outer plate carrier 1 to the inner plates 38. From the inner plates 38, an instantaneous transfer is realized to the inner plate carrier 40 and from there further to the hollow shaft 9.

For wet-running starter clutches, by using the clutch housing on the damper driven side (cf., in particular, the component designated with the reference symbol 11 in FIG. 4), a favorable distribution of the rotational masses can be produced in terms of the vibration isolation. In the case shown in FIG. 4, for example, the ratio between the secondary and primary rotational mass is about 4:1. In the conventional configuration of the wet starter clutch, as described, e.g., in EP 1 371 875 A1, the ratio between the secondary and primary rotational mass is about 1:4.

Through the described arrangements, relative to the previous construction of starter clutches with dampers, in which the clutch housing is connected directly to the flex plate, a significantly larger inertia of masses at the torsional vibration output is produced.

While the inventions have been described by reference to certain specific descriptive examples which may illustrate preferred materials and conditions, it is understood that the inventions are not limited hereto. Rather, all alternatives, modifications and equivalents within the scope of the inventions so described are considered to be within the scope of the appended claims.

1. Powertrain with a torsional vibration damper, with a disk and with a torsional vibration damper housing, which is coupled to the disk elastically so that it can be deflected from rotation about a rotational axis and which at least partially surrounds the disk, and with a clutch device with a clutch housing that can rotate about the rotational axis, the torsional vibration damper housing being connected without rotational play to the clutch housing.

2. Powertrain according to claim 1, wherein the torsional vibration damper housing and the clutch housing together form a housing surrounding the clutch device and the torsional vibration damper.

3. Powertrain according to claim 2, wherein the housing for storing hydraulic fluid is sealed from the surroundings.

4. Powertrain according to claim 1, wherein a bending/flex/swash plate is connected without rotational play to the disk of the torsional vibration damper.

5. Powertrain according to claim 4, wherein a flywheel mass is connected without rotational play to the bending/flex/swash plate.

6. Powertrain according to claim 1, wherein a flywheel mass is connected without rotational play to the disk of the torsional vibration damper.

7. Powertrain according to claim 6, wherein a bending/flex/swash plate is is connected without rotational play to the flywheel mass.

8. Powertrain according to claim 1, wherein the clutch device is one of a wet-running double clutch in axis-parallel construction, a wet-running double clutch in a concentric arrangement, or a wet-running starter clutch.
